(19) United States
(12) Patent Application Publication
(10) Pub. No.: US 2024/0260082 A1
(43) Pub. Date: Aug. 1, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/423,301

(22) Filed: Jan. 26, 2024

(30) Foreign Application Priority Data
Jan. 31, 2023 (CN) 202310093295.0

(51) Int. Cl. H04W 74/08; H04W 52/02

(52) U.S. Cl. CPC H04W 74/08; H04W 52/0225

(57) ABSTRACT

The present application discloses a method and a device for wireless communications, including: receiving a first message on a first cell; transmission time of the first message depending on whether the first message comprises first sub-information; the first sub-information comprising at least one of scheduling of other System Information Blocks (SIBs) of a second cell or information required for an initial access to the second cell; herein, the phrase of transmission time of the first message depending on whether the first message comprises first sub-information comprises that: when the first message comprises the first sub-information, the first message is transmitted at least once per first time length. This application can be more power saving with indication of the first message.

### CROSS REFERENCE TO RELATED APPLICATIONS

This application claims the priority benefit of Chinese Patent Application No. 202310093295.0, filed on January 31,2023, the full disclosure of which is incorporated herein by reference.

### BACKGROUND

### Technical Field

The present application relates to transmission methods and devices in wireless communication systems, relating to the transmission and reception of System Information Blocks and the information required for initial access, in particular to power conservation.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, effective information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), and Device to Device (D2D), Unlicensed Spectrum communications, and monitoring on UE communication quality, network plan optimization, Non-Terrestrial Network (NTN) and Terrestrial Network (TN), Dual connectivity system, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. The way that the UE connects to the network can be direct connection or connection via relay.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

The 3GPP standardization organization has worked on 5G standardization to formulate a series of specifications, of which the details can refer to:
https://www.3gpp.org/ftp/Specs/archive/38_series/38.213/38213-h00.zip
https://www.3gpp.org/ftp/Specs/archive/38_series/38.331/38331-h00.zip
https://www.3gpp.org/ftp/Specs/archive/38_series/38.304/38304-h00.zip

### SUMMARY

In a wireless communication system, when the scheduling of other system information blocks (SIBs) of a second cell and/or the information required for initial access to the second cell is sent by a first cell, it is a problem to be solved as to how to determine the time of transmitting a message carrying the above information from the first cell. The transmitting of scheduling of other SIBs of one cell and/or the information required for initial access to the second cell is essential to the performance of the system in terms of, e.g., saving resources, saving power, improving efficiency, reducing latency of access, etc., and therefore it is preferable that a message carrying the scheduling of other SIBs of the second cell and/or the information required for initial access to the second cell is sent by the first cell at least once in each first time length. Besides, the researchers have found that the subject of the latest studies of the 3GPP relates to the issue of power conservation, and in particular to power conservation at the base station side. The base station may turn off or change the transmission of some signals in order to reduce the transmit power, which is likely to have an impact on the UE's communication. It is important to know which messages still need to be sent when the base station is in a power-saving state, and they must be critical messages, otherwise it would be difficult to save the power of the base station. In addition, researchers have also found that some cells can also save power by not sending messages used for scheduling other system information blocks or messages related to the information needed for access, but instead, they are sent collectively by the first cell, which saves power in the second cell. Whereas the first cell itself may also experience the need for power saving, the researchers have found that how a message from the first cell is sent shall take into account the information it carries, especially when it comes to the scheduling of other system information blocks of and/or information required for initial access to the second cell, the message should be sent at least once in each first time length, namely, by determining the message transmission based on specific content included in the message, power saving can be achieved while also minimizing the impact of receiving other system information blocks of the second cell or accessing the second cell.

To address the problem presented above, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict. Besides, the method proposed in the present application can also be used for addressing other issues confronting communications.

The present application provides a method in a first node for wireless communications, comprising:
receiving a first message on a first cell; transmission time of the first message depending on whether the first message comprises first sub-information; the first sub-information comprising at least one of scheduling of other System Information Blocks (SIBs) of a second cell or information required for an initial access to the second cell;
herein, the phrase of transmission time of the first message depending on whether the first message comprises first sub-information comprises that: when the first message comprises the first sub-information, the first message is transmitted at least once per first time length.

In one embodiment, problems to be solved in the present application include: how to determine the transmitting of the first message; how to determine the time of transmitting the first message based on the content of the first message; how to determine the time of transmitting the first message based on which content is included in the first message; and how to support a cell that does not transmit scheduling information about other system information blocks or information required for initial access.

In one embodiment, advantages of the above method include: saving the power of the base station and providing good flexibility; helping ensure service continuity, preventing the interruption of communications or reducing the duration of interruption; guaranteeing QoS; saving network resources, and shortening the latency of obtaining system information or accessing the second cell.

Specifically, according to one aspect of the present application, receiving a System Information Block 1 (SIB1) of the first cell; herein, the transmission time of the first message depends on scheduling of the SIB1 of the first cell.

Specifically, according to one aspect of the present application, whether the first message comprises the first sub-information depends on a SIB type of the first message.

Specifically, according to one aspect of the present application, whether the first message comprises the first sub-information is related to a SIB type of the first message.

Specifically, according to one aspect of the present application, a type of the first message is any type in a first SIB type set; the first SIB type set comprises at least a first SIB type and a second SIB type; a SIB of the first SIB type comprises the first sub-information; a SIB of the second SIB type does not comprise the first sub-information.

Specifically, according to one aspect of the present application, receiving a first signaling; the first signaling indicating at least one time window; herein, when the first message does not comprise the first sub-information, whether the first message is transmitted at least once in a first time length depends on the at least one time window.

Specifically, according to one aspect of the present application, receiving a System Information Block 1 (SIB1) of the first cell; herein, the SIB1 of the first cell comprises a first field, the first field indicating access-related information of the first cell; the first field comprises a Public Land Mobile Network (PLMN) Identity information list, and the PLMN Identity information list comprised by the first field indicates an identity of the first cell; the second cell is a cell identified by a cell identity other than any cell identity indicated by the PLMN Identity information list comprised by the first field.

Specifically, according to one aspect of the present application, the first node is a terminal of Internet of Things (IoT).

Specifically, according to one aspect of the present application, the first node is a UE.

Specifically, according to one aspect of the present application, the first node is a relay.

Specifically, according to one aspect of the present application, the first node is an access-network device.

Specifically, according to one aspect of the present application, the first node is a vehicle-mounted terminal.

Specifically, according to one aspect of the present application, the first node is an aircraft.

Specifically, according to one aspect of the present application, the first node is a cellphone.

The present application provides a method in a second node for wireless communications, comprising:
transmitting a first message on a first cell; transmission time of the first message depending on whether the first message comprises first sub-information; the first sub-information comprising at least one of scheduling of other System Information Blocks (SIBs) of a second cell or information required for an initial access to the second cell;
herein, the phrase of transmission time of the first message depending on whether the first message comprises first sub-information comprises that: when the first message comprises the first sub-information, the first message is transmitted at least once per first time length.

Specifically, according to one aspect of the present application, transmitting a System Information Block 1 (SIB1) of the first cell; herein, the transmission time of the first message depends on scheduling of the SIB1 of the first cell.

Specifically, according to one aspect of the present application, whether the first message comprises the first sub-information depends on a SIB type of the first message.

Specifically, according to one aspect of the present application, whether the first message comprises the first sub-information is related to a SIB type of the first message.

Specifically, according to one aspect of the present application, a type of the first message is any type in a first SIB type set; the first SIB type set comprises at least a first SIB type and a second SIB type; a SIB of the first SIB type comprises the first sub-information; a SIB of the second SIB type does not comprise the first sub-information.

Specifically, according to one aspect of the present application, transmitting a first signaling; the first signaling indicating at least one time window; herein, when the first message does not comprise the first sub-information, whether the first message is transmitted at least once in a first time length depends on the at least one time window.

Specifically, according to one aspect of the present application, transmitting a System Information Block 1 (SIB1) of the first cell; herein, the SIB1 of the first cell comprises a first field, the first field indicating access-related information of the first cell; the first field comprises a Public Land Mobile Network (PLMN) Identity information list, and the PLMN Identity information list comprised by the first field indicates an identity of the first cell; the second cell is a cell identified by a cell identity other than any cell identity indicated by the PLMN Identity information list comprised by the first field.

Specifically, according to one aspect of the present application, the second node is a network device.

Specifically, according to one aspect of the present application, the second node is a base station.

Specifically, according to one aspect of the present application, the second node is a relay.

Specifically, according to one aspect of the present application, the second node is an access-point.

Specifically, according to one aspect of the present application, the second node is an aircraft.

Specifically, according to one aspect of the present application, the second node is a satellite.

The present application provides a first node for wireless communications, comprising:
a first receiver, which receives a first message on a first cell; transmission time of the first message depending on whether the first message comprises first sub-information; the first sub-information comprising at least one of scheduling of other System Information Blocks (SIBs) of a second cell or information required for an initial access to the second cell;
herein, the phrase of transmission time of the first message depending on whether the first message comprises first sub-information comprises that: when the first message comprises the first sub-information, the first message is transmitted at least once per first time length.

The present application provides a second node for wireless communications, comprising:
a second transmitter, which transmits a first message on a first cell; transmission time of the first message depending on whether the first message comprises first sub-information; the first sub-information comprising at least one of scheduling of other System Information Blocks (SIBs) of a second cell or information required for an initial access to the second cell;
herein, the phrase of transmission time of the first message depending on whether the first message comprises first sub-information comprises that: when the first message comprises the first sub-information, the first message is transmitted at least once per first time length.

In one embodiment, compared with the prior art, the present application is advantageous in the following aspects:
It is more power-saving and more flexible;
it supports different kinds of cells as well as cells with varying power-saving levels or power-saving statuses;
it supports discontinuous transmission of the cell;
it can shorten the UE's interruption time and thus reduce the impact on UE measurement.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first message according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a schematic diagram of transmitting a first message according to one embodiment of the present application.

FIG. 7 illustrates a schematic diagram of transmitting a first message according to one embodiment of the present application.

FIG. 8 illustrates a schematic diagram of scheduling and reception of SIBs according to one embodiment of the present application.

FIG. 9 illustrates a schematic diagram of whether a first message comprises first sub-information being used to determine whether transmission of the first message in a first time length depends on the at least one time window according to one embodiment of the present application.

FIG. 10 illustrates a structure block diagram of a processing device in a first node according to one embodiment of the present application.

FIG. 11 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

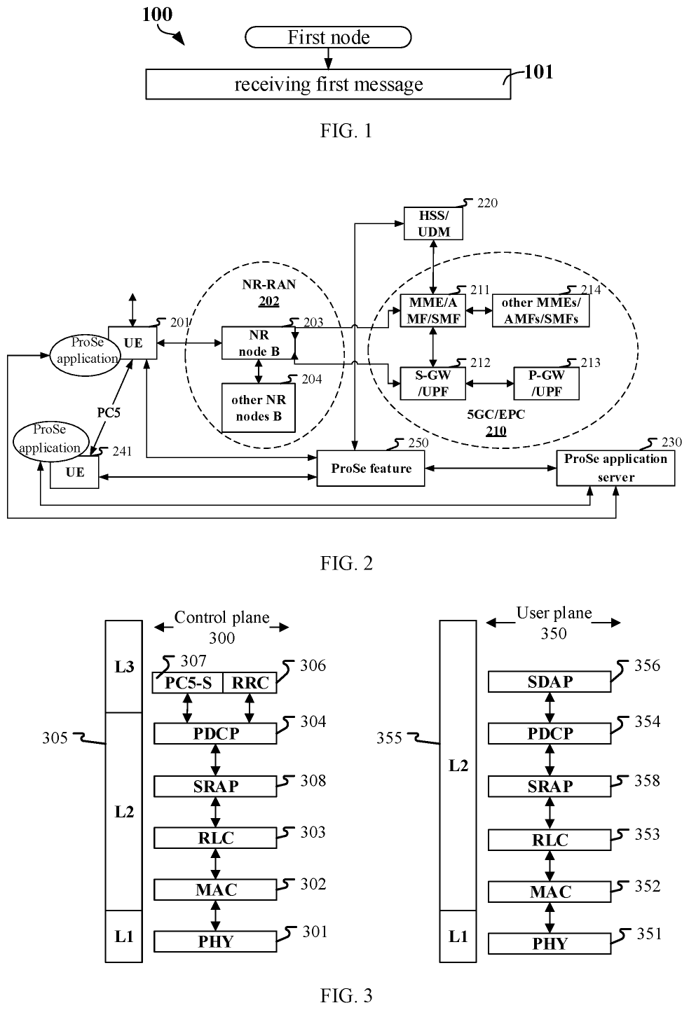

Embodiment 1 illustrates a flowchart of receiving a first message according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first message in step 101;
herein, the first node receives the first message on a first cell; transmission time of the first message depending on whether the first message comprises first sub-information; the first sub-information comprising at least one of scheduling of other System Information Blocks (SIBs) of a second cell or information required for an initial access to the second cell;
herein, the phrase of transmission time of the first message depending on whether the first message comprises first sub-information comprises that: when the first message comprises the first sub-information, the first message is transmitted at least once per first time length.

In one embodiment, the first node is a User Equipment (UE).

In one embodiment, the first node is in RRC_Connected state.

In one embodiment, the first node receives the first message directly from the first cell without using a L2 UE to Network (U2N) relay UE.

In one embodiment, the first node is in RRC_Idle state.

In one embodiment, the first node is in RRC_Inactive state.

In one embodiment, the first cell is a serving cell of the first node.

In one embodiment, after accessing the second cell, the second cell is a serving cell of the first node.

In one embodiment, the first cell is an Anchor Cell of the first node.

In one embodiment, the first cell is an Anchor Cell of the second cell.

In one embodiment, the second cell is a SCell of the first node.

In one subembodiment, the first node is in RRC_Connected state.

In one embodiment, the first cell is a SpCell of the first node.

In one subembodiment, the first node is in RRC_Connected state.

In one embodiment, the first node only keeps connection with one of the first cell or the second cell.

In one embodiment, one of the first cell or the second cell is a serving cell of the first node.

In one embodiment, the first node is camped on one of the first cell or the second cell.

In one subembodiment, the first node is in RRC_Idle state or RRC_Inactive state.

In one embodiment, the first cell is not a serving cell of the first node.

In one subembodiment, the first node is not camped on the first cell.

In one subembodiment, the first node receives the first message from the first cell for accessing the second cell.

In one embodiment, a serving cell refers to a cell that the UE is camped on. Performing cell search includes that the UE searches for a suitable cell for a selected Public Land Mobile Network (PLMN) or Stand-alone Non-Public Network (SNPN), selects the suitable cell to provide available services, and monitors a control channel of the suitable cell, where the whole procedure is defined to be camped on the cell; in other words, a cell camped, relative to the UE, is a serving cell of the UE. Being camped on a cell in either RRC_Idle state or RRC_Inactive state has the following advantages: it allows the UE to receive system information from the PLMN or SNPN; when registered, if the UE expects to establish an RRC connection or continue a suspended RRC connection, the UE can do so by performing an initial access on a control channel of the camping cell; the network can page the UE, allowing the UE to receive notifications from the Earthquake and Tsunami Warning System (ETWS) and Commercial Mobile Alert System (CMAS).

In one embodiment, for a UE in RRC_Connected state without being configured with carrier aggregation/dual connectivity (CA/DC), there is only one serving cell that comprises a primary cell. For a UE in RRC_Connected state that is configured with carrier aggregation/dual connectivity (CA/DC), a serving cell is used for indicating a cell set comprising a Special Cell (SpCell) and all secondary cells. A Primary Cell is a cell in a Master Cell Group (MCG), i.e., an MCG cell, working on the primary frequency, and the UE performs an initial connection establishment procedure or initiates a connection re-establishment on the Primary Cell. For dual connectivity (DC) operation, a special cell refers to a Primary Cell (PCell) in an MCG or a Primary SCG Cell (PSCell) in a Secondary Cell Group (SCG); unless in Dual-Connectivity operation, the special cell refers to a PCell.

In one embodiment, working frequency of a Secondary Cell (SCell) is secondary frequency.

In one embodiment, separate contents in information elements (IEs) are called fields.

In one embodiment, Multi-Radio Dual Connectivity (MR-DC) refers to dual connectivity with an E-UTRA node and an NR node, or with two NR nodes.

In one embodiment, in MR-DC, a radio access node providing a control plane connection to the core network is a master node, where the master node can be a master eNB, a master ng-eNB or a master gNB.

In one embodiment, an MCG refers to a group of serving cells associated with a master node in MR-DC, including a SpCell, and optionally, one or multiple SCells.

In one embodiment, a PCell is a SpCell of an MCG.

In one embodiment, a PSCell is a SpCell of an SCG.

In one embodiment, in MR-DC, a radio access node not providing a control plane connection to the core network but providing extra resources for the UE is a secondary node. The secondary node can be an en-gNB, a secondary ng-eNB or a secondary gNB.

In one embodiment, in MR-DC, a group of serving cells associated with a secondary node is a secondary cell group (SCG), including a SpCell and, optionally, one or multiple SCells.

In one embodiment, the first cell is a SpCell of the first node.

In one subembodiment, the first node is in RRC_Connected state.

In one subembodiment, the first cell is a PCell of the first node.

In one subembodiment, the first cell is a PSCell of the first node.

In one embodiment, the first message is or comprises a system message.

In one embodiment, the first message is or comprises at least one system information block.

In one embodiment, the first message is or comprises a system information block.

In one embodiment, the first message is or comprises a system information block other than SIB1.

In one embodiment, the first message is one of SIB22, SIB23, SIB24, SIB25, SIB26, SIB27, SIB28, SIB29, SIB30, SIB31 or SIB32.

In one embodiment, the first message is transmitted in a broadcast way.

In one embodiment, a logical channel occupied by the first message is a Common Control Channel (CCCH).

In one embodiment, a physical channel occupied by the first message includes a physical downlink control channel (PDSCH).

In one embodiment, the first message is not enciphered.

In one embodiment, the first message is not under integrity protection.

In one embodiment, receiving the first message does not require establishing an RRC connection with the first cell.

In one embodiment, when the first message comprises the first sub-information, transmission of the first message need not be requested.

In one embodiment, transmission of the first message need not be requested.

In one embodiment, the first message is an RRC message.

In one embodiment, the first message is a system message.

In one embodiment, a SIB1 of the first cell indicates that the first message is broadcasting.

In one embodiment, System Information (SI) is classified as a master information block (MIB) and several system information blocks (SIBs) and an optional positioning SIB (posSIB), where the MIB is always transmitted on a Broadcast Channel (BCH) periodically, the MIB comprising cell blocking status information and core physical layer information for obtaining further system information; a SIB1 defines the scheduling of other system information blocks as well as information related to initial access.

In one embodiment, the obtaining of a SIB1 is dependent on a MIB.

In one embodiment, a MIB does not include scheduling of any other SIB.

In one embodiment, a MIB does not include information related to initial access.

In one embodiment, the first message is not a MIB.

In one embodiment, the first message is not a SIB1.

In one embodiment, the action of receiving a first message on a first cell includes a meaning that the first message is a message from the first cell.

In one embodiment, the action of receiving a first message on a first cell includes a meaning that the first message occupies resources of the first cell.

In one embodiment, the action of receiving a first message on a first cell includes a meaning that the first message is scheduled by a SIB1 of the first cell.

In one embodiment, the action of receiving a first message on a first cell includes a meaning that a cell to which the first message belongs is the first cell.

In one embodiment, the action of receiving a first message on a first cell includes a meaning that the first message comprises system information blocks, where a MIB of the system information blocks comprised by the first message defines the first cell.

In one embodiment, the action of receiving a first message on a first cell includes a meaning that an SSB of a first cell defines the first cell, the SSB of the first cell comprising a MIB, the MIB comprised by the SSB of the first cell indicating a SIB1, the SIB1 indicated by the MIB comprised by the SSB of the first cell scheduling the first message.

In one embodiment, a synchronization signal block (SSB) is also a SS/PBCH.

In one embodiment, an SSB is an SS block.

In one embodiment, the action of receiving a first message on a first cell includes a meaning that a SIB1 of the first cell schedules the first message.

In one embodiment, the action of receiving a first message on a first cell includes a meaning that the first message is a system information block of the first cell.

In one embodiment, the sentence of transmission time of the first message depending on whether the first message comprises first sub-information includes a meaning that the transmission time of the first message is variable.

In one embodiment, the sentence of transmission time of the first message depending on whether the first message comprises first sub-information includes a meaning that the transmission time of the first message changes according to whether the first message comprises the first sub-information.

In one embodiment, the sentence of transmission time of the first message depending on whether the first message comprises first sub-information includes a meaning that the transmission time of the first message is different in instances when the first message comprises the first sub-information and in instances when the first message does not comprise the first sub-information.

In one embodiment, the sentence of transmission time of the first message depending on whether the first message comprises first sub-information includes a meaning that the transmission time of the first message can be different in instances when the first message comprises the first sub-information and in instances when the first message does not comprise the first sub-information.

In one embodiment, the sentence of transmission time of the first message depending on whether the first message comprises first sub-information includes a meaning that when the time determined by a first time length does not fall within at least one time window, the transmission time of the first message is different in instances when the first message comprises the first sub-information and in instances when the first message does not comprise the first sub-information.

In one subembodiment, the first node receives a first signaling, the first signaling indicating the at least one time window.

In one embodiment, the first sub-information only comprises a former one of scheduling of other System Information Blocks (SIBs) of the second cell or information required for an initial access to the second cell.

In one embodiment, the first sub-information only comprises a latter one of scheduling of other System Information Blocks (SIBs) of the second cell or information required for an initial access to the second cell.

In one embodiment, the first sub-information only comprises scheduling of other System Information Blocks (SIBs) of the second cell and information required for an initial access to the second cell.

In one embodiment, the second cell is different from the first cell.

In one embodiment, a cell identity of the second cell is different from a cell identity of the first cell.

In one subembodiment, the cell identity comprises 36 bits.

In one subembodiment, the cell identity is used to unquestionably identify a cell within a PLMN range.

In one embodiment, the first cell and the second cell belong to a same PLMN.

In one embodiment, the second cell and the first cell belong to a same Control Unit (CU).

In one embodiment, the second cell and the first cell belong to a same Data Unit (DU).

In one embodiment, the second cell and the first cell belong to a same timing advance group (TAG).

In one embodiment, the second cell and the first cell belong to a same cell group.

In one subembodiment, the first node is in RRC_Connected state.

In one embodiment, the second cell and the first cell do not belong to a same cell group.

In one subembodiment, the first node is in RRC_Connected state.

In one embodiment, the other System Information Blocks (SIBs) of the second cell include system information blocks other than a MIB of the second cell.

In one embodiment, the other System Information Blocks (SIBs) of the second cell include system information blocks other than a MIB and a SIB1 of the second cell.

In one embodiment, the other System Information Blocks (SIBs) of the second cell include at least one of a SIB2, a SIB3, a SIB4 or a SIB5 of the second cell.

In one embodiment, the other System Information Blocks (SIBs) of the second cell include at least one of a SIB6, a SIB7 or a SIB8 of the second cell.

In one embodiment, the other System Information Blocks (SIBs) of the second cell include a SIB9 and/or a SIB19 of the second cell.

In one embodiment, the other System Information Blocks (SIBs) of the second cell include at least one of a SIB11, a SIB15, a SIB16, a SIB17 or a SIB18 of the second cell.

In one embodiment, the other System Information Blocks (SIBs) of the second cell include at least one of a SIB19, a SIB20 or a SIB21 of the second cell.

In one embodiment, scheduling of other System Information Blocks (SIBs) of the second cell includes: a window length of system information for the other SIBs of the second cell.

In one embodiment, scheduling of other System Information Blocks (SIBs) of the second cell includes: a system information area ID for the other SIBs of the second cell.

In one embodiment, scheduling of other System Information Blocks (SIBs) of the second cell includes: a broadcasting status of system information for the other SIBs of the second cell.

In one embodiment, scheduling of other System Information Blocks (SIBs) of the second cell includes: a periodicity of system information for the other SIBs of the second cell.

In one embodiment, scheduling of other System Information Blocks (SIBs) of the second cell includes: mapped information of system information for the other SIBs of the second cell.

In one embodiment, scheduling of other System Information Blocks (SIBs) of the second cell includes: a window location of system information for the other SIBs of the second cell.

In one subembodiment, the mapped information is used for indicating a type of the other system information blocks of the second cell.

In one embodiment, the phrase scheduling of other System Information Blocks (SIBs) of the second cell includes a meaning that the first message comprises a second field, where the second field's name includes SI-SchedulingInfo, the second field in the first message indicating the scheduling of other SIBs of the second cell.

In one embodiment, the first node receives other system information of the second cell according to the scheduling of other System Information Blocks (SIBs) of the second cell comprised by the first message.

In one embodiment, information required for an initial access to the second cell comprises: frequency and/or bandwidth part (BWP).

In one embodiment, information required for an initial access to the second cell comprises: PDCCH configuration.

In one embodiment, information required for an initial access to the second cell comprises: PLMN identity information.

In one embodiment, information required for an initial access to the second cell comprises: Standalone Non-Public Networks (SNPN) identity information.

In one embodiment, information required for an initial access to the second cell comprises: whether the cell is reserved.

In one embodiment, the PLMN identity information comprises at least one of a PLMN identity, a tracking area code, a radio access network (RAN) area code, a cell identity, or a gNB-ID-Length.

In one embodiment, the PLMN identity information comprises at least the PLMN identity of a PLMN identity, a tracking area code, a radio access network (RAN) area code, a cell identity, and a gNB-ID-Length.

In one embodiment, the PLMN identity information comprises at least the cell identity of a PLMN identity, a tracking area code, a radio access network (RAN) area code, a cell identity, and a gNB-ID-Length.

In one embodiment, the first message comprises a third field, the third field's name including cellAccessRelatedInfo, the third field indicating information required for an initial access to the second cell.

In one embodiment, the sentence of the first sub-information comprising at least one of scheduling of other System Information Blocks (SIBs) of a second cell or information required for an initial access to the second cell means that: the first sub-information is used for indicating that at least part of parameters in the scheduling of other SIBs of the second cell are identical to those in scheduling of other SIBs of the first cell.

In one embodiment, the sentence of the first sub-information comprising at least one of scheduling of other System Information Blocks (SIBs) of a second cell or information required for an initial access to the second cell means that: the first sub-information is used for indicating that at least part of parameters in the scheduling of other SIBs of the second cell come from scheduling of other SIBs of the first cell.

In one embodiment, the sentence of the first sub-information comprising at least one of scheduling of other System Information Blocks (SIBs) of a second cell or information required for an initial access to the second cell means that: the first sub-information is used for indicating that at least part of parameters in the information required for an initial access to the second cell come from information required for an initial access to the first cell.

In one embodiment, the second cell transmits a SIB1.

In one subembodiment, the second cell does not transmit any system information block other than a MIB and a SIB1.

In one embodiment, the second cell does not transmit a SIB1.

In one subembodiment, the second cell transmits a MIB.

In one embodiment, the sentence of the first sub-information comprising at least one of scheduling of other System Information Blocks (SIBs) of a second cell or information required for an initial access to the second cell means that: the first message comprises a field, the field comprised by the first message comprising the first sub-information.

In one embodiment, when the first message does not comprise the first sub-information, the first message is not forced to be transmitted at least once in each first time length.

In one embodiment, when the first message does not comprise the first sub-information, the transmission time of the first message depends on scheduling of the base station.

In one embodiment, when the first message does not comprise the first sub-information, the transmission time of the first message depends on implementation of the network.

In one embodiment, when the first message does not comprise the first sub-information, the first node assumes that whether the first message is transmitted at least once in a first time length depends on a first time window set.

In one embodiment, the first message is or comprises any SIB in a first SIB set.

In one embodiment, the first message is or comprises any system message in a first system message set.

In one embodiment, the first message is generated by an RRC layer.

In one embodiment, whether the first message comprises the first sub-information is used to determine whether the first cell is an anchor cell of the second cell; when the first message comprises the first sub-information, the first cell is the anchor cell of the second cell; when the first message does not comprise the first sub-information, the first cell is not the anchor cell of the second cell.

In one embodiment, whether the first message comprises the first sub-information depends on a SIB type of the first message.

In one subembodiment, a SIB1 of the first cell indicates a SIB type of the first message.

In one subembodiment, the first message comprises a SIB type of the first message.

In one subembodiment, the first message is or comprises a system information block.

In one subembodiment, only some SIB types of system information blocks comprise the first sub-information.

In one subembodiment, only one SIB type of system information block comprises the first sub-information.

In one subembodiment, when a SIB type of the first message is a SIB type in a second SIB type set, the first message comprises the first sub-information; when the SIB type of the first message is not a SIB type in the second SIB type set, the first message does not comprise the first sub-information.

In one subembodiment, when the first message comprises the first sub-information, a SIB type of the first message belongs to a second SIB type set; when the first message does not comprise the first sub-information, the SIB type of the first message does not belong to the second SIB type set.

In one subembodiment, the second SIB type set comprises SIB types of all system information blocks that comprise the first sub-information.

In one subembodiment, the second SIB type set consists of SIB types of all system information blocks that comprise the first sub-information.

In one embodiment, a type of the first message is used to determine whether the first message comprises the first sub-information.

In one embodiment, the first node determines whether the first message comprises the first sub-information according to a SIB type of the first message and scheduling information of the first message.

In one embodiment, the first node determines whether the first message comprises the first sub-information according to a SIB type of the first message and a SIB1 of the first cell.

In one embodiment, the first sub-information is only comprised by system information block(s) of a specific SIB type.

In one embodiment, whether the first message comprises the first sub-information is related to a SIB type of the first message.

In one subembodiment, the first message is or comprises a system information block.

In one subembodiment, when the SIB type of the first message belongs to a second SIB type set; the first message necessarily comprises the first sub-information.

In one subembodiment, the second SIB type set comprises SIB types of all system information blocks that comprise the first sub-information.

In one subembodiment, the second SIB type set consists of SIB types of all system information blocks that comprise the first sub-information.

In one subembodiment, when the SIB type of the first message belongs to a second SIB type set and the first cell indicates that the first cell is in a first state; the first message necessarily comprises the first sub-information.

In one subembodiment, the first state is in a state of serving as an anchor of the second cell.

In one subembodiment, the first state is in a network power saving state.

In one subembodiment, the first state is in a discontinuous transmission state.

In one subembodiment, the first cell indicates via a dedicated signaling that the first cell is in the first state.

In one subembodiment, the first cell indicates via a system information block, for instance a SIB1 that the first cell is in the first state.

In one subembodiment, when the SIB type of the first message belongs to a second SIB type set and the first cell indicates that the second cell is in a second state; the first message necessarily comprises the first sub-information.

In one subembodiment, the second state is a state of the second cell being served by an anchor.

In one subembodiment, the second state is in a network power saving state.

In one subembodiment, the second state is in a discontinuous transmission state.

In one subembodiment, the second state is a state of not transmitting system information blocks.

In one subembodiment, the second state is a state of not transmitting system information blocks other than a MIB.

In one subembodiment, the second state is a state of not transmitting system information blocks other than a MIB or a SIB1.

In one subembodiment, the second state is a state of not transmitting a SIB1.

In one subembodiment, the first cell indicates via a dedicated signaling that the second cell is in the second state.

In one subembodiment, the first cell indicates via a system information block, for instance a SIB1 that the second cell is in the second state.

In one embodiment, a type of the first message is any type in a first SIB type set; the first SIB type set comprises at least a first SIB type and a second SIB type; a SIB of the first SIB type comprises the first sub-information; a SIB of the second SIB type does not comprise the first sub-information.

In one subembodiment, the first message is or comprises a system information block.

In one embodiment, system information blocks of only the first SIB type in the first SIB type set comprise the first sub-information.

In one embodiment, none of system information blocks of a SIB type other than the first SIB type in the first SIB type set comprises the first sub-information.

In one embodiment, system information blocks of a first SIB type of the first cell include system information blocks of the first SIB type of the second cell.

In one embodiment, the first SIB type set comprises all SIB types.

In one embodiment, a value of the first SIB type is greater than a value of the second SIB type.

In one embodiment, an index of the first SIB type is greater than an index of the second SIB type.

In one embodiment, a number of the first SIB type is greater than a number of the second SIB type.

In one embodiment, the first SIB type is greater than the second SIB type.

In one subembodiment, the second SIB type is any SIB type of a system information block that does not comprise the first sub-information in the first SIB type set.

In one subembodiment, the first SIB type is any SIB type of a system information block that comprises the first sub-information in the first SIB type set.

In one embodiment, the second cell does not transmit scheduling of any other system information block.

In one embodiment, the second cell does not transmit information required for an initial access.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called a 5G System/Evolved Packet System (5GS/EPS) 200 or other suitable terminology. The 5GS/EPS 200 may comprise one or more UEs 201, an NG-RAN 202, a 5G-Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the first node in the present application is the UE 201.

In one embodiment, a base station of the second node in the present application is the gNB203.

In one embodiment, a radio link from the UE 201 to the NR Node B is an uplink.

In one embodiment, a radio link from the NR Node B to the UE 201 is a downlink.

In one embodiment, the UE 201 supports relay transmission.

In one embodiment, the UE 201 includes cellphone.

In one embodiment, the UE 201 is a means of transportation including automobile.

In one embodiment, the gNB 203 is a MacroCellular base station.

In one embodiment, the gNB203 is a Micro Cell base station.

In one embodiment, the gNB 203 is a PicoCell base station.

In one embodiment, the gNB203 is a flight platform.

In one embodiment, the gNB203 is satellite equipment.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are L1, l2 and L3. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between second nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second node and the first node. A PC5 Signaling Protocol (PC5-S) sublayer 307 is in charge of the processing of signaling protocols for the PC interface. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. An SRB can be seen as service or an interface provided to an upper layer, for instance an RRC layer by the PDCP layer. In the NR system, the SRB includes SRB1, SRB2, SRB3 and sometimes SRB4 when sidelink communications is concerned, which are respectively used for transmissions of different types of control signalings. The SRB is a bearer between the UE and an access network used for transmitting control signalings including RRC signaling. SRB1 has special meaning to UEs, since after each UE establishes an RRC connection, it will have an SRB1, which is used for transmitting RRC signaling, and most of the signaling is transmitted through the SRB1, if the SRB1 is interrupted or unavailable, the UE has to perform RRC re-establishment. SRB2 is generally only used to transmit NAS signaling or signaling related to security. The UE can be configured without SRB3. Unless for urgent traffics, the UE must establish an RRC connection with the network to proceed with communications. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.). For a UE involving relay services, its control plane can also comprise an Adaptation sublayer Sidelink Relay Adaptation Protocol (SRAP) 308, and its user plane can also comprise an Adaptation sublayer SRAP358. The introduction of the Adaptation layer is beneficial to lower layers, for instance, a MAC layer, or an RLC layer, to multiplex and/or distinguish data from multiple source UEs. For nodes not joined in relay communications, none of the PC5-S307, SRAP308 and SRAP358 will be needed in the process of communications.

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the RRC 306.

In one embodiment, the SIB1 in the present application is generated by the RRC 306.

In one embodiment, the first signaling in the present application is generated by the RRC 306.

### Embodiment 4

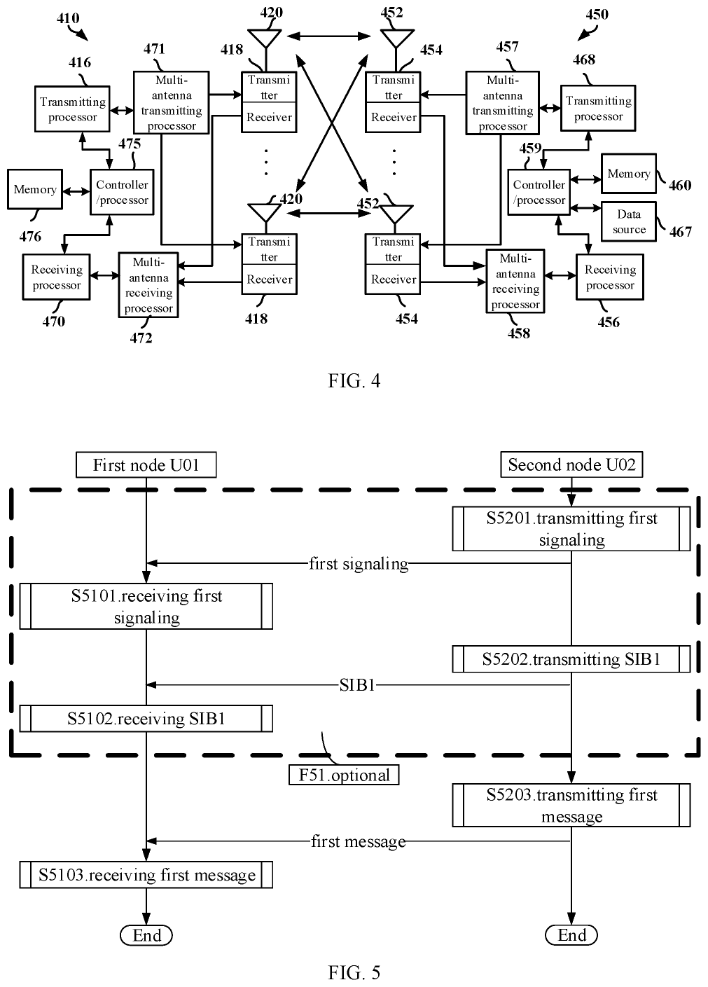

Embodiment 4 illustrates a schematic diagram of a first communication device and a second communication device according to one embodiment of the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, and optionally a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, and optionally a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer (Layer-2). In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any first communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with a memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory. The at least one memory comprises computer program codes; the at least one memory and the computer program codes are configured to be used in collaboration with the at least one processor. The first communication device 450 at least receives a first message on a first cell; transmission time of the first message depending on whether the first message comprises first sub-information; the first sub-information comprising at least one of scheduling of other System Information Blocks (SIBs) of a second cell or information required for an initial access to the second cell; herein, the phrase of transmission time of the first message depending on whether the first message comprises first sub-information comprises that: when the first message comprises the first sub-information, the first message is transmitted at least once per first time length.

In one embodiment, the first communication device 450 comprises a memory that stores computer readable instruction program, the computer readable instruction program generates an action when executed by at least one processor, which includes: receiving a first message on a first cell; transmission time of the first message depending on whether the first message comprises first sub-information; the first sub-information comprising at least one of scheduling of other System Information Blocks (SIBs) of a second cell or information required for an initial access to the second cell; herein, the phrase of transmission time of the first message depending on whether the first message comprises first sub-information comprises that: when the first message comprises the first sub-information, the first message is transmitted at least once per first time length.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first message on a first cell; transmission time of the first message depending on whether the first message comprises first sub-information; the first sub-information comprising at least one of scheduling of other System Information Blocks (SIBs) of a second cell or information required for an initial access to the second cell; herein, the phrase of transmission time of the first message depending on whether the first message comprises first sub-information comprises that: when the first message comprises the first sub-information, the first message is transmitted at least once per first time length.

In one embodiment, the second communication device 410 comprises a memory that stores computer readable instruction program, the computer readable instruction program generates an action when executed by at least one processor, which includes: transmitting a first message on a first cell; transmission time of the first message depending on whether the first message comprises first sub-information; the first sub-information comprising at least one of scheduling of other System Information Blocks (SIBs) of a second cell or information required for an initial access to the second cell; herein, the phrase of transmission time of the first message depending on whether the first message comprises first sub-information comprises that: when the first message comprises the first sub-information, the first message is transmitted at least once per first time length.

In one embodiment, the first communication device 450 corresponds to the first node in the present application.

In one embodiment, the second communication device 410 corresponds to a second node in the present application.

In one embodiment, the first communication device 450 is a UE.

In one embodiment, the first communication device 450 is a vehicle-mounted terminal.

In one embodiment, the first communication device 450 is a relay.

In one embodiment, the second communication device 410 is a satellite.

In one embodiment, the second communication device 410 is an aircraft.

In one embodiment, the second communication device 410 is a base station.

In one embodiment, the receiver 454 (comprising the antenna 452), the receiving processor 456 and the controller/processor 459 are used for receiving the first signaling in the present application.

In one embodiment, the receiver 454 (comprising the antenna 452), the receiving processor 456 and the controller/processor 459 are used for receiving the first message in the present application.

In one embodiment, the receiver 454 (comprising the antenna 452), the receiving processor 456 and the controller/processor 459 are used for receiving the SIB1 in the present application.

In one embodiment, the transmitter 416 (comprising the antenna 420), the transmitting processor 412 and the controller/processor 440 are used for transmitting the first signaling in the present application.

In one embodiment, the transmitter 416 (comprising the antenna 420), the transmitting processor 412 and the controller/processor 440 are used for transmitting the first message in the present application.

In one embodiment, the receiver 416 (comprising the antenna 420), the receiving processor 412 and the controller/processor 440 are used for receiving the SIB1 in the present application.

### Embodiment 5

Embodiment 5 illustrates a flowchart of radio signal transmission according to one embodiment of the present application, as shown in FIG. 5. In FIG. 5, U01 corresponds to the first node in the present application, and U02 corresponds to the second node in the present application. It should be particularly noted that the sequence illustrated herein does not set any limit on the orders in which signals are transmitted and implementations in this present application. Herein, steps in F51 are optional.

The first node U01 receives a first signaling in step S5101; and receives a SIB1 in step S5102; and receives a first message in step S5103.

The second node U02 transmits a first signaling in step S5201; and transmits a SIB1 in step S5202; and transmits a first message in step S5203.

In Embodiment 5, the first node U01 receives the first message on a first cell; transmission time of the first message depending on whether the first message comprises first sub-information; the first sub-information comprising at least one of scheduling of other System Information Blocks (SIBs) of a second cell or information required for an initial access to the second cell; herein, the phrase of transmission time of the first message depending on whether the first message comprises first sub-information comprises that: when the first message comprises the first sub-information, the first message is transmitted at least once per first time length.

In one embodiment, the second node U02 is the first cell.

In one embodiment, the second node U02 is a base station to which the first cell belongs or corresponds.

In one embodiment, a communication interface between the first node U01 and the second node U02 is a Uu interface.

In one embodiment, the first message is a SIB1, and neither of the steps S5202 and S5102 occurs.

In one embodiment, the first message is not a SIB1, and both of the steps S5202 and S5102 occur.

In one embodiment, the step S5201 occurs before the step S5202.

In one embodiment, the step S5202 occurs before the step S5203.

In one embodiment, the first signaling is broadcast.

In one embodiment, the first signaling comprises system information block(s).

In one embodiment, the first signaling comprises a SIB1.

In one subembodiment, the step S5201 and the step S5202 do not co-exist.

In one embodiment, the first signaling is Unicast.

In one embodiment, the first signaling is transmitted by a dedicated channel.

In one embodiment, the first node U01 shall establish an RRC connection with the second node U02 before it can receive the first signaling.

In one embodiment, the first signaling is an RRC message.

In one embodiment, the first signaling is used for RRC reconfiguration.

In one embodiment, the first signaling is or comprises an RRCReconfiguration message.

In one embodiment, after step S5201, the second node U02 transmits L1L2 signaling to activate the at least one time window.

In one subembodiment, upon reception of the first signaling, the at least one time window is not immediately effective.

In one subembodiment, the phrase to activate the at least one time window includes to indicate that the at least one time window is effective.

In one subembodiment, the L1L2 signaling comprises a DCI and/or a MAC CE.

In one embodiment, the first signaling is used to indicate at least one time window.

In one embodiment, the at least one time window is/are for the first cell.

In one embodiment, the at least one time window only includes one time window.

In one embodiment, the at least one time window include multiple time windows.

In one embodiment, the at least one time window include multiple time windows, and each time window of the at least one time window is of equal length.

In one embodiment, the at least one time window include multiple time windows, and the at least one time window include two time windows of unequal time lengths.

In one embodiment, the at least one time window include multiple time windows, and any two adjacent time windows of the at least one time window are spaced by equal time interval.

In one embodiment, the at least one time window include multiple time windows, and time intervals between mutually adjacent time windows of the at least one time window can be unequal.

In one embodiment, any time window of the at least one time window comprises a contiguous period of time.

In one embodiment, any time window of the at least one time window comprises at least one slot.

In one embodiment, any time window of the at least one time window comprises at least one subframe.

In one embodiment, any time window of the at least one time window comprises at least one frame.

In one embodiment, any time window of the at least one time window comprises 2\hat{ }n milliseconds (ms), where \hat{ } is exponential operator, and n is a positive integer.

In one subembodiment, n is no less than 64 ms.

In one embodiment, any time window of the at least one time window comprises an integral multiple of 160 ms.

In one embodiment, the second node U02 determines the at least one time window according to fixed algorithm.

In one embodiment, the second node U02 determines the at least one time window according to an amount of traffic.

In one embodiment, the second node U02 determines the at least one time window at random.

In one embodiment, the first signaling indicates that the second node U02 only receives at a time other than the at least one time window.

In one embodiment, the first signaling indicates that the second node U02 only transmits at a time other than the at least one time window.

In one embodiment, the first signaling indicates that the second node U02 is in a discontinuously transmitting state and/or a discontinuously receiving state within the at least one time window.

In one embodiment, the first signaling indicates that the second node U02 is in a power-saving state in the at least one time window.

In one embodiment, the first node U01 does not expect that a signal transmitted within the at least one time window will be received by the second node U02.

In one embodiment, the first node U01 does not expect that a signal transmitted by the second node U02 can be received within the at least one time window.

In one embodiment, the first node U01 does not expect that any signal other than a reference signal transmitted by the second node U02 can be received within the at least one time window.

In one embodiment, the first node U01 does not expect that any signal other than an SSB transmitted by the second node U02 can be received within the at least one time window.

In one embodiment, the first node U01 does not expect that data transmitted by the second node U02 can be received within the at least one time window.

In one embodiment, the first node U01 does not expect that it will be scheduled by the second node U02 within the at least one time window.

In one embodiment, the first node U01 assumes that it can enter into a dormant state within the at least one time window.

In one embodiment, when the first message does not comprise the first sub-information, whether the first message is transmitted at least once in a first time length depends on the at least one time window.

In one embodiment, when time determined by a first time length belongs to the at least one time window, the first message is not transmitted within the first time length.

In one subembodiment, the first message does not comprise the first sub-information.

In one embodiment, when time determined by a first time length does not belong to the at least one time window, the first message is transmitted within the first time length

In one subembodiment, the first message does not comprise the first sub-information.

In one embodiment, when a transmission occasion of the first message within time determined by a first time length does not belong to the at least one time window, the first message is transmitted within the first time length.

In one subembodiment, the first message does not comprise the first sub-information.

In one embodiment, when a transmission occasion of the first message within time determined by a first time length belongs to the at least one time window, the first message is not transmitted on the transmission occasion that belongs to the at least one time window within the time determined by the first time length.

In one subembodiment, the first message does not comprise the first sub-information.

In one embodiment, whether the first message comprises first sub-information is used to determine whether transmission of the first message in a first time length depends on the at least one time window.

In one subembodiment, the first message does not comprise the first sub-information.

In one embodiment, when the first message comprises the first sub-information, transmission of the first message in each first time length does not depend on the at least one time window.

In one embodiment, a SIB1 of the first cell indicates scheduling of the first message.

In one embodiment, a SIB1 of the first cell indicates periodicity of the first message.

In one embodiment, a SIB1 of the first cell indicates a system information window of the first message.

In one embodiment, the transmission time of the first message depends on scheduling of the SIB1 of the first cell.

In one subembodiment, the SIB1 of the first cell indicates a transmission period of the first message.

In one subembodiment, the SIB1 of the first cell indicates a system time window of transmission of the first message.

In one subembodiment, the SIB1 of the first cell indicates a system time window location of transmission of the first message.

In one embodiment, a si-SchedulingInfo field in a SIB1 of the first cell is used to indicate scheduling of the first message.

In one embodiment, a SIB1 of the first cell indicates a broadcast status of the first message.

In one embodiment, the SIB1 of the first cell comprises a first field, the first field used for indicating access-related information of the first cell.

In one subembodiment, the first field in the SIB1 of the first cell is a CellAccessRelatedInfo field.

In one subembodiment, the first field in the SIB1 of the first cell comprises a PLMN identity information list, the PLMN identity information list being used for accessing; the first node can only access an allowed PLMN.

In one subembodiment, the first field in the SIB1 of the first cell indicates whether a cell can be reserved; the first node can only access cells not reserved.

In one embodiment, the first field of the first cell comprises a Public Land Mobile Network (PLMN) identity information list, and the PLMN identity information list comprised by the first field of the first cell indicates an identity of the first cell.

In one subembodiment, the PLMN identity information list comprised by the first field of the first cell is used for configuring at least one PLMN identity information unit, of which each PLMN identity information unit comprises a list of one or more PLMN identities and other information associated with those PLMNs; and a single PLMN identity can be included only once by an entry of the PLMN identity information list comprised by the first field of the first cell.

In one subembodiment, the PLMN identity information list comprised by the first field of the first cell is not used to configure PLMN identity information of the second cell.

In one subembodiment, the PLMN identity information list comprised by the first field of the first cell is only used to configure PLMN identity information of the first cell.

In one subembodiment, the PLMN identity information list comprised by the first field of the first cell comprises a list of PLMN identity information; each piece of PLMN identity information includes at least the PLMN identity list of a PLMN identity list, a tracking area code, a radio access network (RAN) area code, a list of tracking areas and a gNB-ID-Length.

In one subembodiment, the PLMN identity information list comprised by the first field of the first cell comprises a list of PLMN identity information; each piece of PLMN identity information includes a cell identity.

In one subembodiment, the PLMN identity information list comprised by the first field of the first cell comprises a list of PLMN identity information; each piece of PLMN identity information includes a cell identity; the cell identity comprised by each piece of PLMN identity information is an identity of the first cell.

In one embodiment, the second cell is a cell identified by a cell identity other than that indicated by the PLMN identity information list comprised by the first field of the first cell.

In one embodiment, a field other than the first field in the SIB1 of the first cell indicates an identity of the second cell.

In one embodiment, the PLMN identity information list comprised by the first field in the SIB1 of the first cell only indicates an identity of the first cell.

In one embodiment, each cell identity comprised in a PLMN identity list is unique within the PLMN.

In one embodiment, an identity of the second cell is different from an identity of the first cell.

In one embodiment, a 32-bit identity used to identify the first cell is different from a 32-bit identity used to identify the second cell.

### Embodiment 6

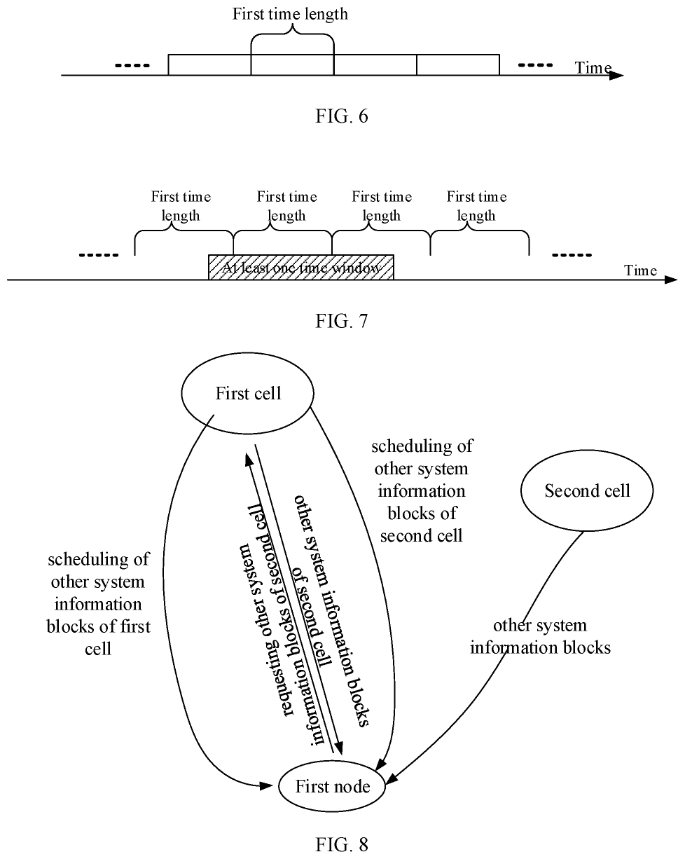

Embodiment 6 illustrates a schematic diagram of transmitting a first message according to one embodiment of the present application, as shown in FIG. 6.

In FIG. 6, each rectangle symbolizes a first time length.

In one embodiment, the first time length is fixed.

In one embodiment, the first time length is determined based on network protocols.

In one embodiment, the first time length is configured by the network.

In one embodiment, the first time length is known.

In one embodiment, a SIB1 of the first cell indicates the first time length.

In one embodiment, the first time length is a period of the first message.

In one subembodiment, a SIB1 of the first cell indicates the period of the first message.

In one embodiment, the first time length is a system information block window of the first message.

In one subembodiment, a SIB1 of the first cell indicates a system information block window of the first message.

In one embodiment, a MIB of the first cell implicitly indicates the first time length.

In one embodiment, a value of the first time length is 160 ms.

In one embodiment, a candidate value of the first time length is one of 8 radio frames, 16 radio frames, 32 radio frames, 64 radio frames, 128 radio frames, 256 radio frames or 512 radio frames.

In one embodiment, the phrase that the first message is transmitted at least once per first time length means that: each first time length is any period of time in time domain with a length being the first time length.

In one embodiment, the phrase that the first message is transmitted at least once per first time length means that: each first time length is orthogonal in time domain.

In one embodiment, the phrase that the first message is transmitted at least once per first time length means that: each first time length is contiguous in time domain.

In one embodiment, the phrase that the first message is transmitted at least once per first time length means that: the time determined by a first time length is orthogonal with the time determined by another first time length in time domain.

In one embodiment, the phrase that the first message is transmitted at least once per first time length means that: the time determined by the first time length starts at a determined time, for instance, if the first time length is n radio frames, then each first time length starts when a value of a system frame number modulo the first time length is a specific value.

In one subembodiment, the specific value is 0.

In one subembodiment, the specific value is configured by the network.

In one embodiment, the phrase that the first message is transmitted at least once per first time length means that: a start of the time determined by the first time length is configured by the network.

In one embodiment, the phrase that the first message is transmitted at least once per first time length means that: the start of each first time length is not arbitrary.

In one embodiment, the phrase that the first message is transmitted at least once per first time length means that: the start of each first time length is dependent on a system frame number, each first time length starting only at a specific system frame number.

In one embodiment, the phrase that the first message is transmitted at least once per first time length means that: the start of each first time length is dependent on a value of a system frame number modulo the first time length, each first time length starting only when the value of the system frame number modulo the first time length is a specific value.

In one embodiment, the phrase that the first message is transmitted at least once per first time length means that: the first message is transmitted only once in each first time length.

In one embodiment, the phrase that the first message is transmitted at least once per first time length means that: the first message is transmitted more than once in each first time length.

In one embodiment, the phrase that the first message is transmitted at least once per first time length means that: the first message is repeatedly transmitted multiple times in each first time length.

In one embodiment, the phrase that the first message is transmitted at least once per first time length means that: the first message is transmitted at a fixed time within each first time length.

In one embodiment, the phrase that the first message is transmitted at least once per first time length means that: transmission of the first message in each first time length is scheduled by a PDCCH.

In one embodiment, the phrase that the first message is transmitted at least once per first time length means that: transmission of the first message in each first time length depends on a system information block (SIB) time window.

In one subembodiment, the SIB time window is indicated by a SIB1 of the first cell.

In one subembodiment, the first message is transmitted only in a SIB time window per first time length.

In one subembodiment, the first message is transmitted via scheduling of the network in a SIB time window per first time length.

In one embodiment, the SIB time window comprises x slots, where x is a positive integer.

In one subembodiment, x is one of 5, 10, 20, 40, 80, 160, 320, 640, 1280, 2560, or 5120.

In one embodiment, the phrase that the first message is transmitted at least once per first time length means that: a number of times the first message is transmitted in each first time length is fixed.

In one embodiment, the phrase that the first message is transmitted at least once per first time length means that: a number of times the first message is transmitted in each first time length is configured by the network.

In one subembodiment, a SIB1 of the first cell is used to configure a number of times the first message is transmitted per first time length.

In one embodiment, the phrase that the first message is transmitted at least once per first time length means that: the first message is transmitted in a period of a first time length.

In one embodiment, the phrase that the first message is transmitted at least once per first time length means that: the time interval between two adjacent transmissions of the first message includes at least two types of time intervals.

In one embodiment, the phrase that the first message is transmitted at least once per first time length means that: transmission of the first message is not periodic.

In one embodiment, each first time length refers to a time-domain window that periodically occurs.

In one embodiment, a System Information Block (SIB) of the first cell carries a different system information area ID from a SIB of the second cell.

In one embodiment, a SIB time window is no longer than the first time length.

### Embodiment 7

Embodiment 7 illustrates a schematic diagram of transmitting a first message according to one embodiment of the present application, as shown in FIG. 7.

In one embodiment, the at least one time window includes only one time window.

In one embodiment, the at least one time window include multiple time windows.

In one embodiment, the at least one time window include multiple periodically repeated time windows.

In one embodiment, the at least one time window include multiple time windows, and any two adjacent time windows of the at least one time window are spaced by equal time interval.

In one embodiment, time windows included by the at least one time window are of equal lengths.

In one embodiment, there are two time windows of unequal lengths among the at least one time window.

In one embodiment, any time window of the at least one time window comprises at least one slot.

In one embodiment, any time window of the at least one time window comprises at least one millisecond of time.

In one embodiment, any time window of the at least one time window comprises at least one subframe of time.

In one embodiment, any time window of the at least one time window comprises at least one frame of time.

In one embodiment, a first signaling indicates the at least one time window.

In one embodiment, a first signaling indicates length(s) and period(s) of the at least one time window.

In one embodiment, a start of any time window of the at least one time window depends on a start of each first time length.

In one embodiment, a start of any time window of the at least one time window does not depend on a start of each first time length.

In one embodiment, a length of any time window of the at least one time window is a positive integral multiple of the first time length.

In one subembodiment, a length of any time window of the at least one time window is at least twice the size of the first time length.

In one subembodiment, a length of any time window of the at least one time window is larger than the first time length.

In one subembodiment, a length of any time window of the at least one time window is no smaller than the first time length.

In one embodiment, the first message is transmitted at least once in each first time length, the each first time length starting only at a specific time.

In one embodiment, the at least one time window is/are for the first cell.

In one embodiment, the at least one time window is/are the time during which the first cell enters into a discontinuous transmission state.

In one embodiment, the at least one time window is/are the time during which the first cell enters into a discontinuous reception state.

In one embodiment, the at least one time window is/are the time during which the first cell enters into a discontinuous reception and discontinuous transmission state.

In one embodiment, the at least one time window is/are the time during which the first cell enters into a power-saving state.

In one embodiment, the first node transmits only during the time other than the at least one time window.

In one embodiment, the first node receives only during the time other than the at least one time window.

In one embodiment, the first node does not expect that it will be scheduled by the first cell within the at least one time window.

In one embodiment, the first node does not expect that it will be scheduled with resources of the first cell within the at least one time window.

In one embodiment, the first node does not expect that data transmitted within the at least one time window will be received.

In one embodiment, transmission of the first message in each first time length depends on whether the first message comprises the first sub-information.

In one embodiment, when the first message does not comprise the first sub-information, transmission of the first message in each first time length depends on whether the first message comprises the first sub-information.

In one embodiment, when the first message comprises the first sub-information, the first message is transmitted at least once in each first time length.

In one embodiment, when the first message comprises the first sub-information, the first message is transmitted at least once within each first time length, regardless of whether the transmission of the first message is within the at least one time window.

In one embodiment, when the first message comprises the first sub-information, transmission of the first message in each first time length does not depend on the at least one time window.

In one embodiment, when the first message does not comprise the first sub-information, the first message is transmitted only at a time that is not part of the at least one time window in each first time length.

In one embodiment, when the first message does not comprise the first sub-information, as assumed by the first node, the first message is transmitted only at the time that is not part of the at least one time window in the each first time length.

In one embodiment, when the first message does not comprise the first sub-information, as assumed by the first node, the first message can be transmitted only at the time that is not part of the at least one time window in the each first time length.

In one embodiment, when the first message does not comprise the first sub-information, the first node does not expect that the first message is transmitted only at the time that is part of the at least one time window in the each first time length.

In one embodiment, when the first message does not comprise the first sub-information and the at least one time window includes time determined by a first time length, the first message is not transmitted.

In one subembodiment, the time determined by the first time length is any piece of the time respectively determined by each first time length.

In one embodiment, when the first message does not comprise the first sub-information and the at least one time window includes time determined by a first time length, the first message is not required to be transmitted or is not required to be received.

In one subembodiment, the time determined by the first time length is any piece of the time respectively determined by each first time length.

In one embodiment, when the first message does not comprise the first sub-information and the at least one time window includes time determined by a first time length, the first node does not expect that the first message will be transmitted.

In one subembodiment, the time determined by the first time length is any piece of the time respectively determined by each first time length.

In one embodiment, the first signaling indicates the at least one time window by indicating time other than the at least one time window.

In one embodiment, the at least one time window includes/include inactive time of the first cell.

In one embodiment, the first cell indicates a second time window set.

In one embodiment, the first signaling comprises a second time window set.

In one embodiment, the second time window set is for the second cell.

In one embodiment, the second time window set is inactive time of the second cell.

In one embodiment, the first node assumes that the second cell transmits and/or receives only at a time other than the second time window set.

In one embodiment, the first node assumes that the second cell transmits and/or receives data only at a time other than the second time window set.

In one embodiment, the first node assumes that the second cell transmits and/or receives a signal only at a time other than the second time window set.

In one embodiment, the first node assumes that the second cell transmits the other SIBs only at a time other than the second time window set.

In one embodiment, the first node assumes that the second cell transmits the other SIBs of the second cell only at a time other than the second time window set.

In one embodiment, the second cell does not transmit a MIB.

In one embodiment, the second cell does not transmit a SIB1.

### Embodiment 8

Embodiment 8 illustrates a schematic diagram of scheduling and reception of SIBs according to one embodiment of the present application, as shown in FIG. 8.

The solid line with arrowhead in FIG. 8 illustrates the direction of information transmission.

In one embodiment, the first cell indicates the scheduling of other system information blocks (SIBs) of the first cell.

In one embodiment, the first cell indicates the scheduling of other system information blocks (SIBs) of the second cell.

In one embodiment, the first cell indicates the scheduling of other System Information Blocks (SIBs) of the first cell and the scheduling of other System Information Blocks (SIBs) of the second cell simultaneously via the first message.

In one embodiment, the first cell indicates the scheduling of other System Information Blocks (SIBs) of the second cell and indicates the scheduling of other System Information Blocks (SIBs) of the first cell via the SIB1.

In one embodiment, the second cell does not indicate the scheduling of other system information blocks (SIBs) of the second cell.

In one embodiment, the scheduling of other system information blocks (SIBs) of the second cell depends on the scheduling of other system information blocks (SIBs) of the first cell.

In one embodiment, the scheduling of other system information blocks (SIBs) of the second cell does not depend on the scheduling of other system information blocks (SIBs) of the first cell.

In one embodiment, the first cell indicates the scheduling of other system information blocks (SIBs) of the first cell by means of broadcast.

In one embodiment, the first cell indicates the scheduling of other system information blocks (SIBs) of the first cell by means of unicast.

In one embodiment, the first cell indicates the scheduling of other system information blocks (SIBs) of the second cell by means of broadcast.

In one embodiment, the first cell indicates the scheduling of other system information blocks (SIBs) of the second cell only by means of broadcast.

In one embodiment, the first cell indicates the scheduling of other system information blocks (SIBs) of the second cell by means of unicast.

In one embodiment, whether the first cell indicates the scheduling of other system information blocks (SIBs) of the first cell by broadcast or unicast is related to an RRC state of the first node.

In one embodiment, whether the first cell indicates the scheduling of other system information blocks (SIBs) of the second cell by broadcast or unicast is related to an RRC state of the first node.

In one embodiment, the second cell broadcasts other system information blocks (SIBs) of the second cell.

In one embodiment, the second cell periodically broadcasts other system information blocks (SIBs) of the second cell.

In one embodiment, the second cell broadcasts other system information blocks (SIBs) of the second cell upon request.

In one embodiment, the second cell broadcasts the other SIBs of the second cell only at a time other than the second time window set.

In one embodiment, the second cell does not transmit other system information blocks (SIBs) of the second cell.

In one embodiment, the first cell periodically transmits other system information blocks (SIBs) of the second cell.

In one embodiment, the first cell transmits other system information blocks (SIBs) of the second cell upon request.

In one embodiment, the first message indicates whether the first cell transmits other system information blocks (SIBs) of the second cell.

In one embodiment, the first message indicates whether the first cell can be requested to transmit other system information blocks (SIBs) of the second cell.

In one embodiment, the first node requests from the first cell other system information blocks (SIBs) of the second cell, the first node receiving from the second cell other SIBs of the second cell.

In one embodiment, the first node requests from the first cell other system information blocks (SIBs) of the second cell, the first node receiving from the first cell other SIBs of the second cell.

In one embodiment, a SIB1 of the first cell or the first message indicates resources occupied by other system information blocks (SIBs) of the second cell being requested.

In one subembodiment, the first node requests from the first cell other system information blocks (SIBs) of the second cell.

In one embodiment, a SIB1 of the first node or the first message indicates a PDCCH that schedules other system information blocks (SIBs) of the second cell being requested.

In one subembodiment, the first node requests from the first cell other system information blocks (SIBs) of the second cell.

In one embodiment, a SIB1 of the first node or the first message indicates an SSB associated with a PDCCH that schedules other system information blocks (SIBs) of the second cell being requested.

In one subembodiment, the first node requests from the first cell other system information blocks (SIBs) of the second cell.

In one subembodiment, the associated SSB is an SSB of the first cell or an SSB of the second cell.

In one subembodiment, the first node requests other system information blocks (SIBs) of the second cell by means of an Msg1 in a random access procedure.

In one subembodiment, the first node requests from the first cell other system information blocks (SIBs) of the second cell.

In one subembodiment, the Msg1 is a first message in the random access procedure.

In one subembodiment, the Msg1 is a Preamble.

In one subembodiment, the first node requests other system information blocks (SIBs) of the second cell by means of an Msg3 in a random access procedure.

In one subembodiment, the first node requests from the first cell other system information blocks (SIBs) of the second cell.

In one subembodiment, the Msg3 is a third message in the random access procedure.

In one subembodiment, the Msg3 is an RRC message.

In one subembodiment, the first node requests other system information blocks (SIBs) of the second cell by means of an MsgA in a random access procedure.

In one subembodiment, the first node requests from the first cell other system information blocks (SIBs) of the second cell.

In one subembodiment, the MsgA is a message A in a 2-step random access procedure.

In one embodiment, a SIB1 of the first cell or the first message is used to indicate resources occupied by a signal for requesting other system information blocks (SIBs) of the second cell.

In one embodiment, a SIB1 of the first cell or the first message is used to indicate resources occupied by a signal for requesting other system information blocks (SIBs) of the second cell; the resource are resources of the first cell or are associated with an SSB of the first cell or are associated with a physical cell identity (PCI) of the first cell.

In one embodiment, resources occupied by a signal for requesting other system information blocks (SIBs) of the second cell that is transmitted to the first cell by the first node are different from resources occupied by a signal for requesting other system information blocks (SIBs) of the first cell that is transmitted to the first cell by the first node.

In one embodiment, resources occupied by a signal for requesting other system information blocks (SIBs) of the second cell that is transmitted to the first cell by the first node are the same as resources occupied by a signal for requesting other system information blocks (SIBs) of the first cell that is transmitted to the first cell by the first node.

In one subembodiment, the first node transmits a signal for requesting other system information blocks (SIBs) of the first cell via a dedicated signaling or Msg3 or MsgA.

In one subembodiment, the first node transmits a signal for requesting other system information blocks (SIBs) of the second cell via a dedicated signaling or Msg3 or MsgA.

### Embodiment 9

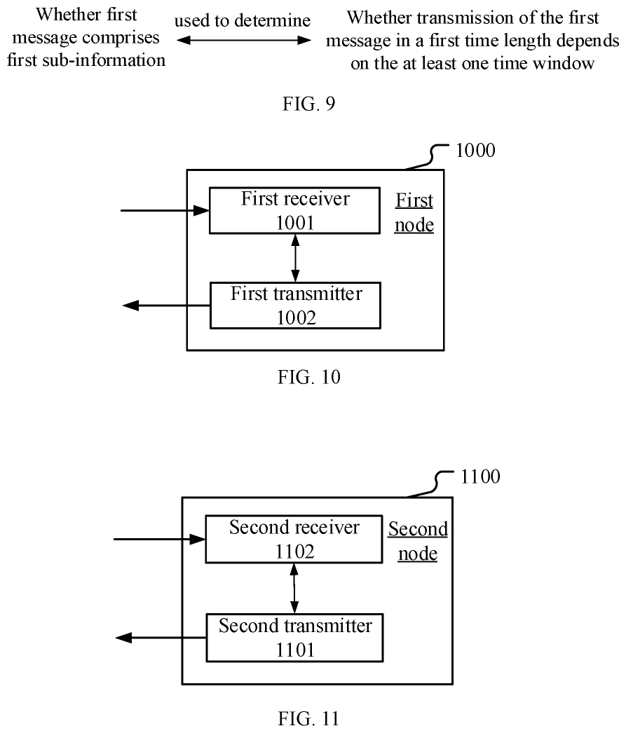

Embodiment 9 illustrates a schematic diagram of whether a first message comprises first sub-information being used to determine whether transmission of the first message in a first time length depends on the at least one time window according to one embodiment of the present application, as shown in FIG. 9.

In one embodiment, the first signaling indicates the at least one time window.

In one embodiment, the at least one time window in Embodiment 9 can refer to embodiments of the at least one time window provided in Embodiment 7.

In one embodiment, when the first message comprises the first sub-information, transmission of the first message in a first time length does not depend on the at least one time window.

In one embodiment, when the first message does not comprise the first sub-information, transmission of the first message in a first time length depends on the at least one time window.

In one embodiment, the phrase of depending on the at least one time window means: the first message is transmitted only during the time other than the at least one time window.

In one embodiment, the phrase of depending on the at least one time window means: the first message is transmitted only during the time other than the at least one time window, and won't be transmitted in the first 4 ms of a start of a time window of the at least one time window.

In one embodiment, a first time length mentioned is one of the each first time length mentioned.

In one embodiment, the first message is not a SIB1 of the first cell.

In one embodiment, the first message comprises a SIB1 of the second cell.

### Embodiment 10

Embodiment 10 illustrates a structure block diagram of a processing device used in a first node according to one embodiment of the present application, as shown in FIG. 10. In FIG. 10, a first node's processing device 1000 is comprised of a first receiver 1001 and a first transmitter 1002. In Embodiment 10,
the first receiver 1001 receives a first message on a first cell; transmission time of the first message depending on whether the first message comprises first sub-information; the first sub-information comprising at least one of scheduling of other System Information Blocks (SIBs) of a second cell or information required for an initial access to the second cell;
herein, the phrase of transmission time of the first message depending on whether the first message comprises first sub-information comprises that: when the first message comprises the first sub-information, the first message is transmitted at least once per first time length.

In one embodiment, the first receiver 1001 receives a System Information Block 1 (SIB1) of the first cell;
herein, the transmission time of the first message depends on scheduling of the SIB1 of the first cell.

In one embodiment, whether the first message comprises the first sub-information depends on a SIB type of the first message.

In one embodiment, whether the first message comprises the first sub-information is related to a SIB type of the first message.

In one embodiment, a type of the first message is any type in a first SIB type set; the first SIB type set comprises at least a first SIB type and a second SIB type; a SIB of the first SIB type comprises the first sub-information; a SIB of the second SIB type does not comprise the first sub-information.

In one embodiment, the first receiver 1001 receives a first signaling, the first signaling indicating at least one time length;
herein, when the first message does not comprise the first sub-information, whether the first message is transmitted at least once in a first time length depends on the at least one time window.

In one embodiment, the first receiver 1001 receives a System Information Block 1 (SIB1) of the first cell;
herein, the SIB1 of the first cell comprises a first field, the first field indicating access-related information of the first cell; the first field comprises a Public Land Mobile Network (PLMN) Identity information list, and the PLMN Identity information list comprised by the first field indicates an identity of the first cell; the second cell is a cell identified by a cell identity other than any cell identity indicated by the PLMN Identity information list comprised by the first field.

In one embodiment, the first node is a UE.

In one embodiment, the first node is a terminal supporting NTN.

In one embodiment, the first node is an aircraft or vessel.

In one embodiment, the first node is a cellphone or vehicle-mounted terminal.

In one embodiment, the first node is a relay UE and/or a U2N remote UE.

In one embodiment, the first node is an IoT terminal or IIoT terminal.

In one embodiment, the first node is a piece of equipment supporting transmissions with low delay and high reliability.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

### Embodiment 11

Embodiment 11 illustrates a structure block diagram of a processing device used in a second node according to one embodiment of the present application, as shown in FIG. 11. In FIG. 11, a second node's processing device 1100 comprises a second transmitter 1101 and a second receiver 1102. In Embodiment 11,
the second transmitter 1101 transmits a first message on a first cell; transmission time of the first message depending on whether the first message comprises first sub-information; the first sub-information comprising at least one of scheduling of other System Information Blocks (SIBs) of a second cell or information required for an initial access to the second cell;
herein, the phrase of transmission time of the first message depending on whether the first message comprises first sub-information comprises that: when the first message comprises the first sub-information, the first message is transmitted at least once per first time length.

In one embodiment, the second transmitter 1101 transmits a System Information Block 1 (SIB1) of the first cell; herein, the transmission time of the first message depends on scheduling of the SIB1 of the first cell.

In one embodiment, whether the first message comprises the first sub-information depends on a SIB type of the first message.

In one embodiment, whether the first message comprises the first sub-information is related to a SIB type of the first message.

In one embodiment, a type of the first message is any type in a first SIB type set; the first SIB type set comprises at least a first SIB type and a second SIB type; a SIB of the first SIB type comprises the first sub-information; a SIB of the second SIB type does not comprise the first sub-information.

In one embodiment, the second transmitter 1101 transmits a first signaling; the first signaling indicating at least one time window; herein, when the first message does not comprise the first sub-information, whether the first message is transmitted at least once in a first time length depends on the at least one time window.

In one embodiment, the second transmitter 1101 transmits a System Information Block 1 (SIB1) of the first cell; herein, the SIB1 of the first cell comprises a first field, the first field indicating access-related information of the first cell; the first field comprises a Public Land Mobile Network (PLMN) Identity information list, and the PLMN Identity information list comprised by the first field indicates an identity of the first cell; the second cell is a cell identified by a cell identity other than any cell identity indicated by the PLMN Identity information list comprised by the first field.

In one embodiment, the second node is a satellite.

In one embodiment, the second node is a base station.

In one embodiment, the second node is a relay.

In one embodiment, the second node is an access point.

In one embodiment, the second node is a multicast-supporting node.

In one embodiment, the second transmitter 1101 comprises at least one of the antenna 420, the transmitter 418, the transmitting processor 416, the multi-antenna transmitting processor 471, the controller/processor 475 or the memory 476 in Embodiment 4.

In one embodiment, the second receiver 1102 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IoT), RFID terminals, NB-IoT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment.

This disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, characterized in comprising:
a first receiver, which receives a first message on a first cell; transmission time of the first message depending on whether the first message comprises first sub-information; the first sub-information comprising at least one of scheduling of other System Information Blocks (SIBs) of a second cell or information requested for an initial access of the second cell;
wherein the phrase of transmission time of the first message depending on whether the first message comprises first sub-information comprises that: when the first message comprises the first sub-information, the first message is transmitted at least once per first time length.

2. The first node according to claim 1, characterized in comprising:
the first receiver, receiving a System Information Block 1 (SIB1) of the first cell;
wherein the transmission time of the first message depends on scheduling of the SIB1 of the first cell.

3. The first node according to claim 1, characterized in that
whether the first message comprises the first sub-information depends on a SIB type of the first message.

4. The first node according to claim 2, characterized in that
whether the first message comprises the first sub-information depends on a SIB type of the first message.

5. The first node according to claim 1, characterized in that
whether the first message comprises the first sub-information is related to a SIB type of the first message.

6. The first node according to claim 1, characterized in that
a type of the first message is any type in a first SIB type set; the first SIB type set comprises at least a first SIB type and a second SIB type; a SIB of the first SIB type comprises the first sub-information; a SIB of the second SIB type does not comprise the first sub-information.

7. The first node according to claim 2, characterized in that
a type of the first message is any type in a first SIB type set; the first SIB type set comprises at least a first SIB type and a second SIB type; a SIB of the first SIB type comprises the first sub-information; a SIB of the second SIB type does not comprise the first sub-information.

8. The first node according to claim 1, characterized in comprising:
the first receiver, receiving a first signaling; the first signaling indicating at least one time window;
wherein when the first message does not comprise the first sub-information, whether the first message is transmitted at least once in a first time length depends on the at least one time window.

9. The first node according to claim 2, characterized in comprising:
the first receiver, receiving a first signaling; the first signaling indicating at least one time window;
wherein when the first message does not comprise the first sub-information, whether the first message is transmitted at least once in a first time length depends on the at least one time window.

10. The first node according to claim 3, characterized in comprising:
the first receiver, receiving a first signaling; the first signaling indicating at least one time window;
wherein when the first message does not comprise the first sub-information, whether the first message is transmitted at least once in a first time length depends on the at least one time window.

11. The first node according to claim 1, characterized in comprising:
the first receiver, receiving a System Information Block 1 (SIB1) of the first cell;
wherein the SIB1 of the first cell comprises a first field, the first field indicating access-related information of the first cell; the first field comprises a Public Land Mobile Network (PLMN) Identity information list, and the PLMN Identity information list comprised by the first field indicates an identity of the first cell; the second cell is a cell identified by a cell identity other than any cell identity indicated by the PLMN Identity information list comprised by the first field.

12. The first node according to claim 2, characterized in comprising:
the first receiver, receiving a System Information Block 1 (SIB1) of the first cell;
wherein the SIB1 of the first cell comprises a first field, the first field indicating access-related information of the first cell; the first field comprises a Public Land Mobile Network (PLMN) Identity information list, and the PLMN Identity information list comprised by the first field indicates an identity of the first cell; the second cell is a cell identified by a cell identity other than any cell identity indicated by the PLMN Identity information list comprised by the first field.

13. The first node according to claim 3, characterized in comprising:
the first receiver, receiving a System Information Block 1 (SIB1) of the first cell;
wherein the SIB1 of the first cell comprises a first field, the first field indicating access-related information of the first cell; the first field comprises a Public Land Mobile Network (PLMN) Identity information list, and the PLMN Identity information list comprised by the first field indicates an identity of the first cell; the second cell is a cell identified by a cell identity other than any cell identity indicated by the PLMN Identity information list comprised by the first field.

14. The first node according to claim 6, characterized in comprising:
the first receiver, receiving a System Information Block 1 (SIB1) of the first cell;
wherein the SIB1 of the first cell comprises a first field, the first field indicating access-related information of the first cell; the first field comprises a Public Land Mobile Network (PLMN) Identity information list, and the PLMN Identity information list comprised by the first field indicates an identity of the first cell; the second cell is a cell identified by a cell identity other than any cell identity indicated by the PLMN Identity information list comprised by the first field.

15. The first node according to claim 8, characterized in comprising:
the first receiver, receiving a System Information Block 1 (SIB1) of the first cell;
wherein the SIB1 of the first cell comprises a first field, the first field indicating access-related information of the first cell; the first field comprises a Public Land Mobile Network (PLMN) Identity information list, and the PLMN Identity information list comprised by the first field indicates an identity of the first cell; the second cell is a cell identified by a cell identity other than any cell identity indicated by the PLMN Identity information list comprised by the first field.

16. A second node for wireless communications, comprising:
a second transmitter, which transmits a first message on a first cell; transmission time of the first message depending on whether the first message comprises first sub-information; the first sub-information comprising at least one of scheduling of other System Information Blocks (SIBs) of a second cell or information requested for an initial access of the second cell;
wherein the phrase of transmission time of the first message depending on whether the first message comprises first sub-information comprises that: when the first message comprises the first sub-information, the first message is transmitted at least once per first time length.

17. The second node according to claim 16, characterized in comprising:
the second transmitter, which transmits a System Information Block 1 (SIB1) on the first cell;
wherein the transmission time of the first message depends on scheduling of the SIB1 of the first cell.

18. A method in a first node for wireless communications, comprising:
receiving a first message on a first cell; transmission time of the first message depending on whether the first message comprises first sub-information; the first sub-information comprising at least one of scheduling of other System Information Blocks (SIBs) of a second cell or information requested for an initial access of the second cell;
wherein the phrase of transmission time of the first message depending on whether the first message comprises first sub-information comprises that: when the first message comprises the first sub-information, the first message is transmitted at least once per first time length.

19. The method in the first node according to claim 18, characterized in comprising:
receiving a System Information Block 1 (SIB1) on the first cell;
wherein the transmission time of the first message depends on scheduling of the SIB1 of the first cell.

20. The method in the first node according to claim 18, characterized in that
whether the first message comprises the first sub-information depends on a SIB type of the first message.
